(19) United States
(12) Patent Application Publication
(10) Pub. No.: US 2013/0284715 A1
(43) Pub. Date: Oct. 31, 2013

(54) HEATING SYSTEM FOR HEATING SEMICONDUCTOR MATERIAL DISPOSED IN A CRUCIBLE

(71) Applicants: Hsin-Hwa HU, New Taipei City (TW); Tsung-Te LAI, New Taipei City (TW); Hung-Chao CHIANG, New Taipei City (TW)

(72) Inventors: Hsin-Hwa HU, New Taipei City (TW); Tsung-Te LAI, New Taipei City (TW); Hung-Chao CHIANG, New Taipei City (TW)

(73) Assignee: C Sun Mfg. Ltd., New Taipei City (TW)

(21) Appl. No.: 13/619,704

(22) Filed: Sep. 14, 2012

(30) Foreign Application Priority Data
Apr. 25, 2012 (CN) 201210124235.2

(51) Int. Cl. F27B 14/06; F27B 14/20

(52) U.S. Cl. 219/422; 219/425; 373/135

(57) ABSTRACT

A heating system includes first and second heating devices, a temperature sensor, a first controller and a second controller. The first and second heating devices are respectively arranged above a crucible and around the crucible for heating semiconductor material in the crucible. The temperature sensor is configured to detect the temperature of the first heating device and to generate a temperature signal. The first controller is configured to control operation of the first heating device so as to adjust the temperature thereof based on the temperature signal. The second controller is coupled to the second heating device and is configured to control operation of the second heating device so as to adjust the temperature thereof, based on an external control signal.

### CROSS-REFERENCE TO RELATED APPLICATION

This application claims priority of Chinese Application No. 201210124235.2, filed on Apr. 25, 2012.

### BACKGROUND OF THE INVENTION

1. Field of the Invention

The invention relates to a heating system, more particularly to a heating system for heating semiconductor material.

2. Description of the Related Art

A crystal growing procedure is crucial in a solar cell manufacturing process. During the crystal growing procedure, semiconductor material is disposed in a crucible, heated therein and melted so as to form molten semiconductor material which, when cooled, can be formed into crystal material that can be applied to a solar cell for converting solar energy to electrical energy. Heating of the semiconductor material must be carefully controlled in order to obtain the crystal material with better quality.

Additionally, as shown in FIG. 1, it is preferable that the heating procedure is controlled such that the temperature at the bottom of the crucible is kept at a predetermined temperature, and that the temperatures in the crucible 900 are distributed with a predetermined gradient along a vertical direction (as indicated by line H in FIG. 1). For example, the temperature is preferable to be higher at near the top of the crucible and to be lower at the bottom thereof (see FIG. 2). It is also preferable that a convective motion of the semiconductor material 901 be induced inside the crucible 900 during the heating procedure (as indicated by the dashed arrows in FIG. 1).

FIGS. 3 and 4 illustrate a conventional heating device that is for heating semiconductor material 901 disposed in the crucible 900. The heating device includes a top heater 93 disposed above the crucible 900 and a side heater 97 disposed around the crucible 900. The heating device further includes two temperature sensors 94 and 98 for detecting temperatures of the top heater 93 and the side heater 97, respectively, and is operable to control two power switches 91 and 95 using two controllers 90 and 99 in order to adjust heating powers outputted by the top heater 93 and the side heater 97, respectively.

Nonetheless, detection by the temperature sensors 94 and 98 may not be accurate, due to interference from the unintended heater (e.g., the temperature sensor 94 may receive interference from the side heater 97). Moreover, the temperature sensor has a relatively high manufacturing cost, and it is not preferable to use two temperature sensors simultaneously in one heating device.

FIG. 5 illustrates another conventional heating device. In this configuration, only one of the controller 90, one of the power switch 91 and one of the temperature sensor 94 are used, so that a lower manufacturing cost is achieved. However, the temperatures of the top heater 93 and the side heater 97 cannot be adjusted accurately by the controller 90, and as a result, the quality of the crystal material may not be optimized.

FIG. 6 illustrates yet another conventional heating device. In this configuration, the side heater 97 is omitted in order to obtain a larger gradient along the vertical direction. However, the heating procedure using this configuration may be more time-consuming due to the fact that only one heater (the top heater 93) is operational.

### SUMMARY OF THE INVENTION

Therefore, the object of the present invention is to provide a heating system that is suitable for growing crystal material with good quality and good yield.

Accordingly, a heating system of the present invention is for heating semiconductor material disposed in a crucible. The heating system comprises first and second heating devices, a temperature sensor, a first controller and a second controller.

The first and second heating devices are to be respectively arranged above the crucible and around the crucible for heating the semiconductor material in the crucible.

The temperature sensor is configured to detect the temperature of the first heating device and to generate a temperature signal based on the temperature of the first heating device detected thereby.

The first controller is coupled to the first heating device and the temperature sensor. The first controller is configured to control operation of the first heating device so as to adjust the temperature of the first heating device toward a preset default temperature based on the temperature signal generated by the temperature sensor.

The second controller is coupled to the second heating device and is configured to receive an external control signal and to control operation of the second heating device so as to adjust the temperature of the second heating device based on the external control signal.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram illustrating preferable condition of semiconductor material during a heating procedure;

FIG. 2 is a plot of a preferable temperature distribution during the heating procedure, taken along line H in FIG. 1;

FIG. 3 is a schematic diagram of a conventional heating device;

FIG. 4 is a schematic block diagram illustrating components of the conventional heating device of FIG. 3;

FIG. 5 is a schematic block diagram illustrating components of another conventional heating device;

FIG. 6 is a schematic block diagram illustrating components of yet another conventional heating device;

FIG. 7 is a schematic diagram of a preferred embodiment of a heating system according to the invention;

FIG. 8 is a schematic block diagram illustrating components of the preferred embodiment; and

FIG. 9 is a plot illustrating temperature distributions of the heating devices shown in FIGS. 5, 6 and 8.

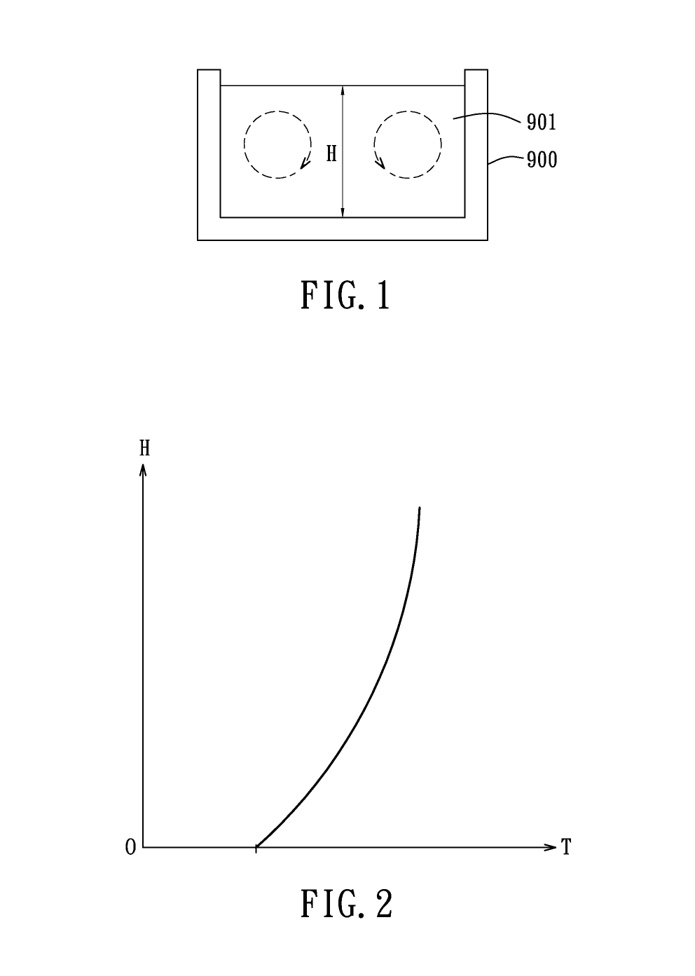

### DETAILED DESCRIPTION OF THE PREFERRED EMBODIMENT

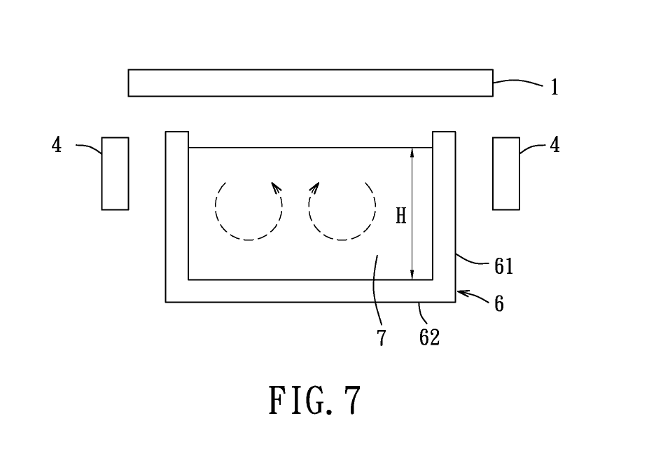

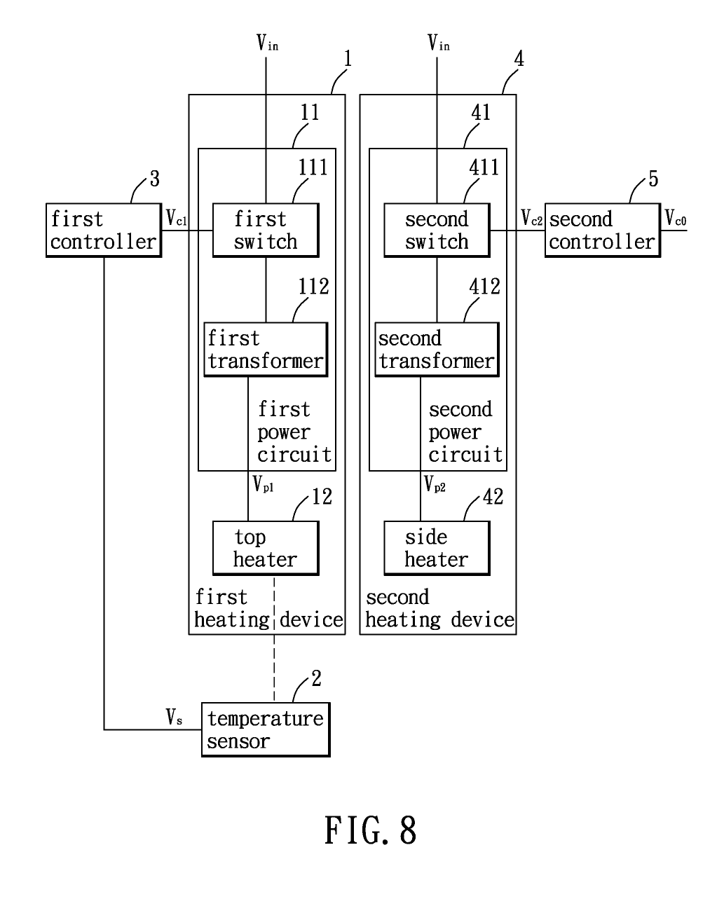

As shown in FIGS. 7 and 8, the preferred embodiment of a heating system according to the present invention includes a first heating device 1, a temperature sensor 2, a first controller 3, a second heating device 4, and a second controller 5. The heating system is for heating semiconductor material 7 disposed in a crucible 6. The crucible 6 is typically placed on a platform (not shown), and has a bottom wall 62 and a surrounding wall 61 extending upwardly from a periphery of the bottom 62.

The first heating device 1 is arranged above the crucible 6, and includes a first power circuit 11 and a first heater 12. The first power circuit 11 is electrically connected to the first controller 3 for receiving a first control signal Vc₁ therefrom, and is configured to generate a first power signal Vp₁ with an adjustable duty cycle that is correlated to the first control signal Vc₁. The first heater 12 is electrically connected to the first circuit 11 and is controlled by the first power signal Vp₁ so as to generate heat for heating the semiconductor material 7 in the crucible 6. For example, when the temperature of the first heater 12 needs to be higher, the duty cycle of the first power signal Vp₁ is increased, thereby increasing power outputted by the first heater 12.

The first power circuit 11 includes a first switch 111 and a first transformer 112. The first switch 111 has one end configured to receive an input power signal Vᵢₙ and another end electrically connected to the first transformer 112. The first switch 111 is coupled to the first controller 3 and is controlled by the first control signal Vc₁ to switch between a non-conducting state and a conducting state. The first transformer 112 is operable to adjust voltage of the power signal from the first switch 111.

The temperature sensor 2 is configured to detect the temperature of the first heating device 1 and to generate a temperature signal Vₛ based on the temperature of the first heating device 1 detected thereby.

The first controller 3 is coupled to the first heating device 1 and the temperature sensor 2, and is configured to control operation of the first heating device 1 so as to adjust, via the first control signal Vc₁, the temperature of the first heating device 1 toward a preset default temperature configured therein based on the temperature signal Vₛ generated by the temperature sensor 2.

The second heating device 4 is arranged around the crucible 6 (e.g. , on an outer surface of the surrounding wall 61) , and includes a second power circuit 41 and a second heater 42. The second power circuit 41 is electrically connected to the second controller 5 for receiving a second control signal Vc₂ therefrom, and is configured to generate a second power signal Vp₂ with an adjustable duty cycle that is correlated to the second control signal Vc₂. The second heater 42 is electrically connected to the second circuit 41 and is controlled by the second power signal Vp₂ so as to generate heat for heating the semiconductor material 7 in the crucible 6. For example, when the temperature of the second heater 42 needs to be higher, the duty cycle of the second power signal Vp₂ is increased, thereby increasing power outputted by the second heater 42.

The second power circuit 41 includes a second switch 411 and a second transformer 412. The second switch 411 has one end configured to receive the input power signal Vᵢₙ and another end electrically connected to the second transformer 412. The second switch 411 is coupled to the second controller 5 and is controlled by the second control signal Vc₂ to switch between a non-conducting state and a conducting state. The second transformer 412 is operable to adjust voltage of the power signal from the second switch 411.

The second controller 5 is coupled to the second heating device 4, and is configured to receive an external control signal Vc₀ and to control operation of the second heating device 4 so as to adjust the temperature of the second heating device 4 based on the external control signal Vc₀. In this embodiment, the external control signal Vc₀ is generated according to a predetermined user-defined heating schedule stored in an external control circuit (not shown).

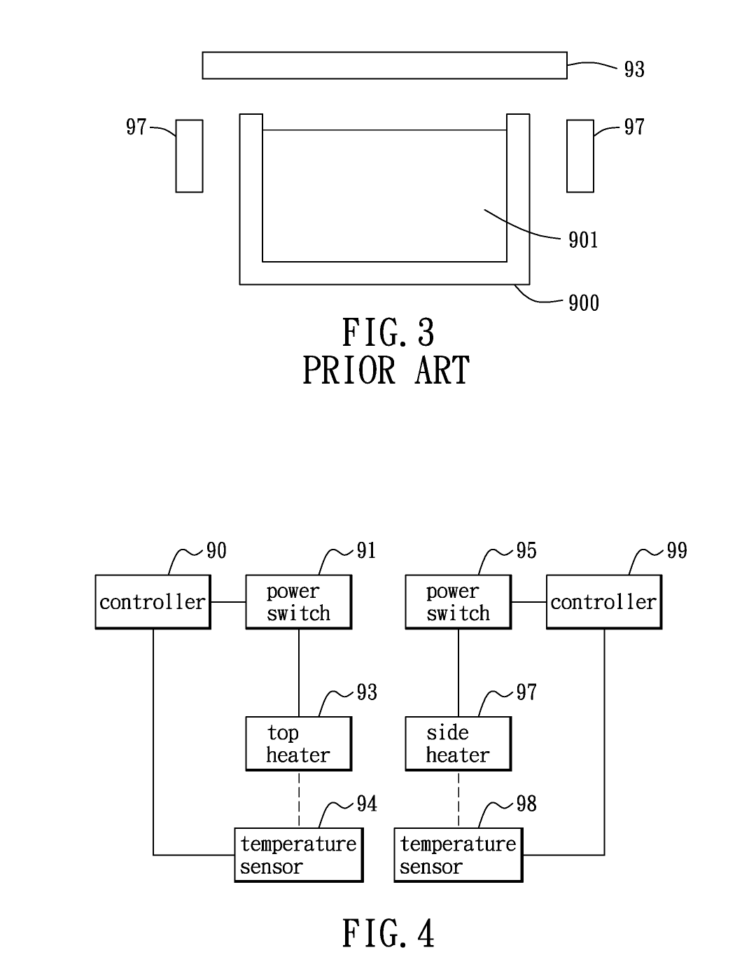

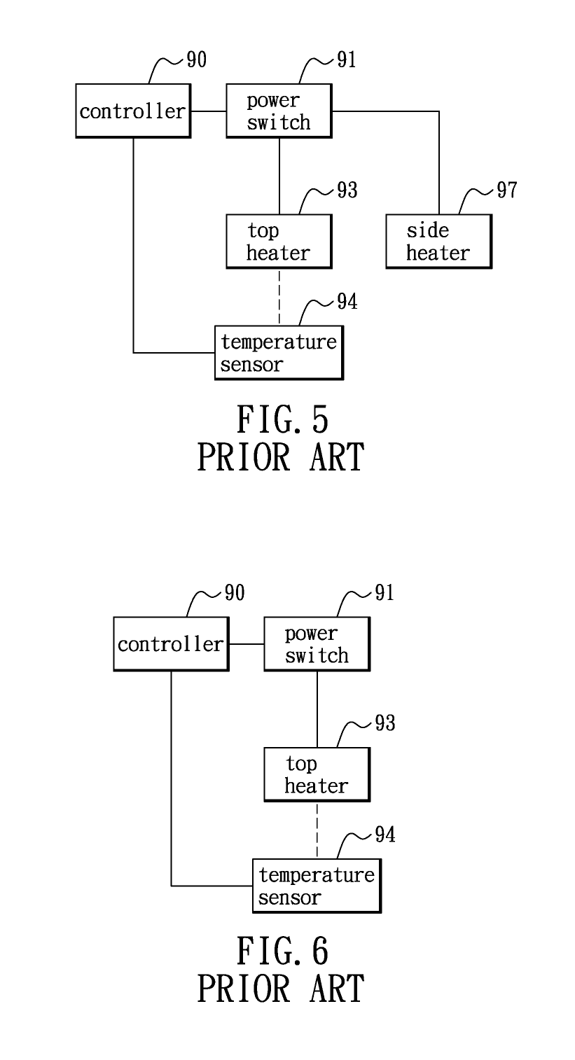

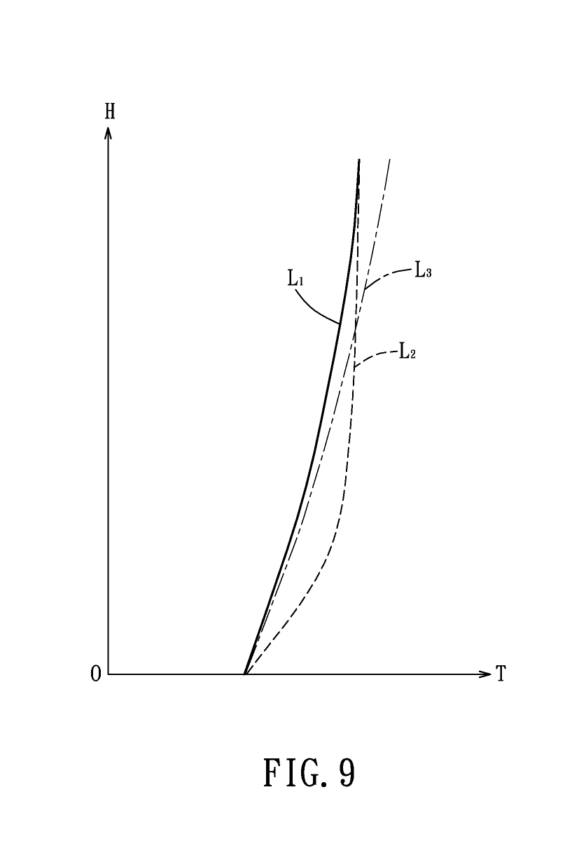

FIG. 9 illustrates temperatures of the semiconductor material 7 on different heights of the crucible 6. The segments L₁, L₂ and L₃ represent the results of this embodiment (see FIG. 8), the heating device as shown in FIG. 3 and the heating device as shown in FIG. 4, respectively. According to segment L₂, at higher locations of the crucible, temperatures thereof are almost uniform, resulting in substantially no gradient along the vertical direction. According to segment L₃, without the side heater 97, in order to keep the temperature at the bottom of the crucible 900 at the predetermined temperature, the top heater 93 is required to output more power (see FIG. 4) than the combined power outputted by the first and second heating devices 1 and 4 in this embodiment.

To sum up, the heating system of this invention utilizes the second controller 5 to control temperature of the second heating device 4, such that interference from the first heating device 1 can be avoided, and that only one temperature sensor 2 is required. In addition, convective motion of the semiconductor material 7 inside the crucible 6 during the heating procedure is achieved using the first and second heating device 1 and 4.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A heating system for heating semiconductor material disposed in a crucible, said heating system comprising:
first and second heating devices to be respectively arranged above the crucible and around the crucible for heating the semiconductor material in the crucible;
a temperature sensor configured to detect the temperature of said first heating device and to generate a temperature signal based on the temperature of said first heating device detected thereby;
a first controller coupled to said first heating device and said temperature sensor and configured to control operation of said first heating device so as to adjust the temperature of said first heating device toward a preset default temperature based on the temperature signal generated by said temperature sensor; and
a second controller coupled to said second heating device and configured to receive an external control signal and to control operation of said second heating device so as to adjust the temperature of said second heating device based on the external control signal.

2. The heating system as claimed in claim 1, wherein said first heating device includes:
a first power circuit electrically connected to said first controller for receiving a first control signal therefrom, and configured to generate a first power signal with an adjustable duty cycle that is correlated to the first control signal; and
a first heater electrically connected to said first power circuit and controlled by the first power signal so as to generate heat for heating the semiconductor material in the crucible.

3. The heating system as claimed in claim 2, wherein said second heating device includes:
a second power circuit electrically connected to said second controller for receiving a second control signal therefrom, and configured to generate a second power signal with an adjustable duty cycle that is correlated to the second control signal; and
a second heater electrically connected to said second power circuit and controlled by the second power signal so as to generate heat for heating the semiconductor material in the crucible.

4. The heating system as claimed in claim 3, wherein said first power circuit is configured to receive an input power signal and includes:
a first transformer electrically connected to said first heater; and
a first switch that has one end configured to receive the input power signal and another end electrically connected to said first transformer, and that is coupled to said first controller and controlled by the first control signal to switch between a non-conducting state and a conducting state.

5. The heating system as claimed in claim 4, wherein said second power circuit is configured to receive the input power signal and includes:
a second transformer electrically connected to said second heater; and
a second switch that has one end configured to receive the input power signal and another end electrically connected to said second transformer, and that is coupled to said second controller and controlled by the second control signal to switch between a non-conducting state and a conducting state.
